(19) United States
(12) Patent Application Publication
(10) Pub. No.: US 2002/0117368 A1
(43) Pub. Date: Aug. 29, 2002

(54) Feeder System

(75) Inventor: Kazuyoshi Ogasawara, Susono-shi (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/082,155

(22) Filed: Feb. 26, 2002

(30) Foreign Application Priority Data
Feb. 26, 2001 (JP) P2001-050778

(51) Int. Cl. B60L 1/00

(52) U.S. Cl. 191/2

(57) ABSTRACT

To supply electric power from a vehicle body (1) of an automobile having a high-voltage power supply line (6) to a door unit (2) serving as a fed member having a low-voltage power supply line (7) whose voltage is lower than that of the high-voltage power supply line, the vehicle body 1 is provided with a primary noncontact connector (4) having a primary coil (14) and connected to the high-voltage power supply line (6), and the door unit is provided with a secondary noncontact connector 5 having a secondary coil (25) in which a voltage-lowered induced electromotive force capable of being supplied to the low-voltage power supply line is generated due to the action of mutual induction as the primary coil is brought into close proximity to the secondary coil, the door member being connected to the low-voltage power supply line.

### BACKGROUND OF THE INVENTION

The present invention relates to a feeder system for vehicle which supplies electric power from a vehicle body of the vehicle to fed members (a member to which electric power is supplied) through the action of mutual induction between a primary coil and a secondary coil.

In recent years, vehicles in which a sliding door (which is one of door units included among the fed members) is slidably installed in a vehicle body have come to be provided with high performance functions. In conjunction with this trend toward high performance functions, a power window, for example, is provided in the sliding door, and there has arisen a need to supply electric power for driving the power window to the sliding door. Accordingly, in recent years, various feeder systems for sliding doors have been proposed for the purpose of supplying electric power from the vehicle body of an automobile to the sliding door. Hereafter, a brief description will be given of a feeder system for a sliding door serving as a fed member.

In FIG. 2, a vehicle body 51 is provided with a body-side feeding contact 54 (J/C SW) which, when a sliding door 52 is closed, is brought into contact with a door-side feeding contact 53 (J/C SW) provided on the sliding door 52 to establish electrical contact therewith. The body-side feeding contact 54 is connected to a battery 55 provided in the vehicle body 51. A door-side controller 56 is disposed in the sliding door 52. The door-side controller 56 is configured by having a chargeable door-use battery 57, and the door-side feeding contact 53 is connected to the door-use battery 57. The door-use battery 57 is adapted to supply electric power to a pressure sensor 58 and a pressure sensitive switch 59 which are provided on the sliding door 52 when the sliding door 52 is opened, and the door-side feeding contact 53 and the body-side feeding contact 54 is in a state of noncontact.

FIG. 3A shows a schematic diagram of the body-side feeding contact 54. FIG. 3B shows a schematic diagram of the door-side feeding contact 53. Reference numeral 60 in FIG. 3A denotes a known female terminal (female connector). Reference numeral 61 in FIG. 3B denotes a known male terminal (male connector) which is brought into contact with the female terminal 60 to be electrically connected thereto when the sliding door 52 (see FIG. 2) is closed.

With the above-described related art, the feeding of electric power from the vehicle body 51 to the sliding door 52 is effected through the electrical connection between the door-side feeding contact 53 and the body-side feeding contact 54. However, there has been a problem in that short-circuiting occurs in the event that the electrically connecting portion between the body-side feeding contact 54 and the door-side feeding contact 53 is splashed with water due to some cause, or an electrically conductive material (e.g., a thin metal plate) happens to be nipped between the body-side feeding contact 54 and the door-side feeding contact 53 (apprehension has been felt over accidents of combustion or an electric shock, affecting the safety).

In feeding electric power from the vehicle body 51 to a door unit (a door for a driver's seat or a passenger seat, or a rear hatch) other than the sliding door 52, a grommet, (although not particularly shown) is provided between the vehicle body 51 and the other door unit, and a wire harness is passed therethrough to supply electric power. However, the operation of passing the wire harness through the grommet is very troublesome, and there has been a demand for eliminating that passing operation.

Recently, there has emerged a move to increase the voltage at a power supply line provided in the vehicle body 51 to a higher voltage (e.g., 36 V) so as to decrease the power transmission loss. For this reason, a high voltage has come to be applied to the body-side feeding contact 54 and the door-side feeding contact 53, so that an early resolution of the aforementioned problem of short-circuiting has been desired.

It should be noted that even if the voltage on the vehicle body 51 side is made high, the same 12 V system as the conventional system is used for motors with relatively low torques disposed in the sliding door 52 and other door units (the door for a driver's seat or a passenger seat, or a rear hatch).

As the 12 V system is used, in a case where electric power is supplied to the aforementioned motors, it has been necessary to supply electric power either by providing the sliding door 52 and other door units with, for example, DC-DC converters, respectively, to cause the voltage to drop to 12 V and supply the dropped power supply to the motors, or by providing the vehicle body 51 with, for example, a DC-DC converter to cause the voltage to drop to 12 V and draw lines to the sliding door 52 and other door units through new power supply lines.

In either case, however, the above-described problem of the short-circuiting and the problem of the passing operation are not overcome, and there is the problem that the new installation of the DC-DC converter leads to higher cost. There is the problem that in the case where the new power supply lines for a low voltage are drawn, the advantage concerning the reduction of the power transmission loss becomes mitigated.

### SUMMARY OF THE INVENTION

The invention has been devised in view of the above-described circumstances, and its object is to provide a feeder system which is inexpensive, improves the safety and operating efficiency, and contributes to the reduction of the power transmission loss.

In order to solve the aforesaid object, the invention is characterized by having the following arrangement.

(1) A feeder system for supplying electric power from a vehicle body of a vehicle to a fed member, the feeder system comprising:

a high-voltage power supply line, for supplying the electric power of first voltage, provided to the vehicle body;

a primary noncontact connector including primary coil and connected to the high-voltage power supply line;

a low-voltage power supply line, for supplying the electric power of second voltage lower than the first voltage, provided to the fed member; and

a secondary noncontact connector connected to the lower-voltage power supply line and including a secondary coil generating an induced electromotive force as the primary coil is brought into close proximity to the secondary coil, wherein the secondary coil converts the electric power of the first voltage supplied from the primary coil to the electric power of the second voltage in cooperation with the primary coil.

(2) The feeder system according to (1), wherein the primary noncontact connector is detachable from the vehicle body, and the secondary noncontact connector is detachable from the fed member.

(3) The feeder system according to (1), wherein

the primary noncontact connector includes a primary core around which the primary coil is wound,

the secondary noncontact connector includes a secondary core around which the secondary coil is wound, and

a winding ratio between the secondary coil and the primary coil is so set that the first voltage is converted to the second voltage.

(4) The feeder system according to (1), wherein the first voltage is 36 V and the second voltage is 12 V.

### BRIEF DESCRIPTION OF THE DRAWINGS

FIG. 1 is a block diagram illustrating an embodiment of the feeder system in accordance with the invention;

FIG. 2 is a schematic diagram of a conventional feeder system (a feeder system for a sliding door serving as a fed member); and

FIG. 3A is a schematic diagram of a body-side feeding contact shown in FIG. 2; and

FIG. 3B is a schematic diagram of a door-side feeding contact shown in FIG. 2.

### DETAILED DESCRIPTION OF PREFERRED EMBODIMENTS

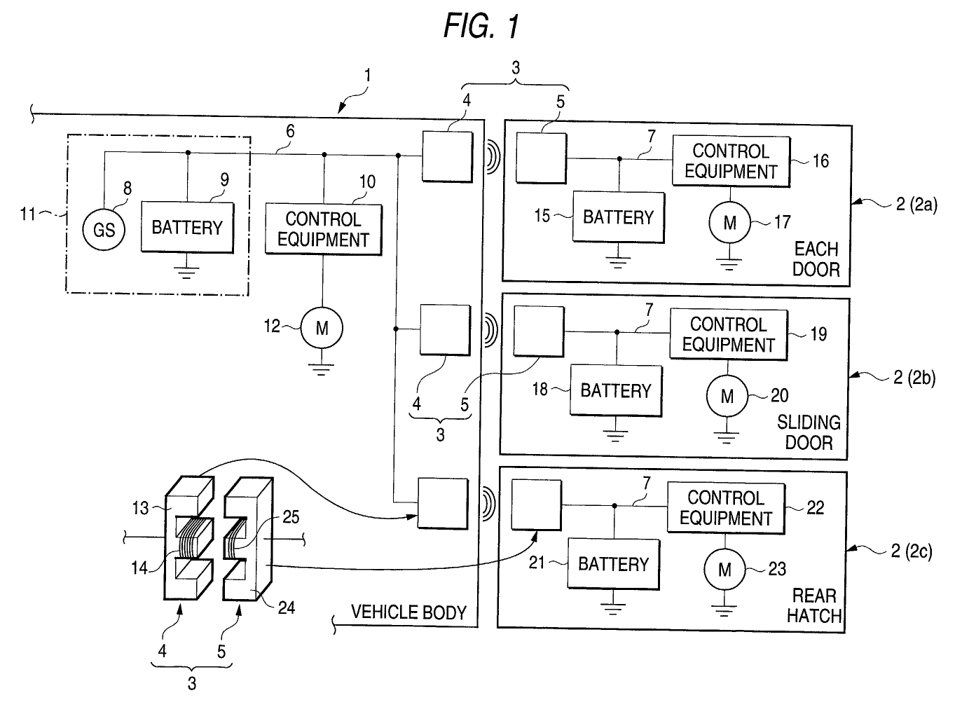

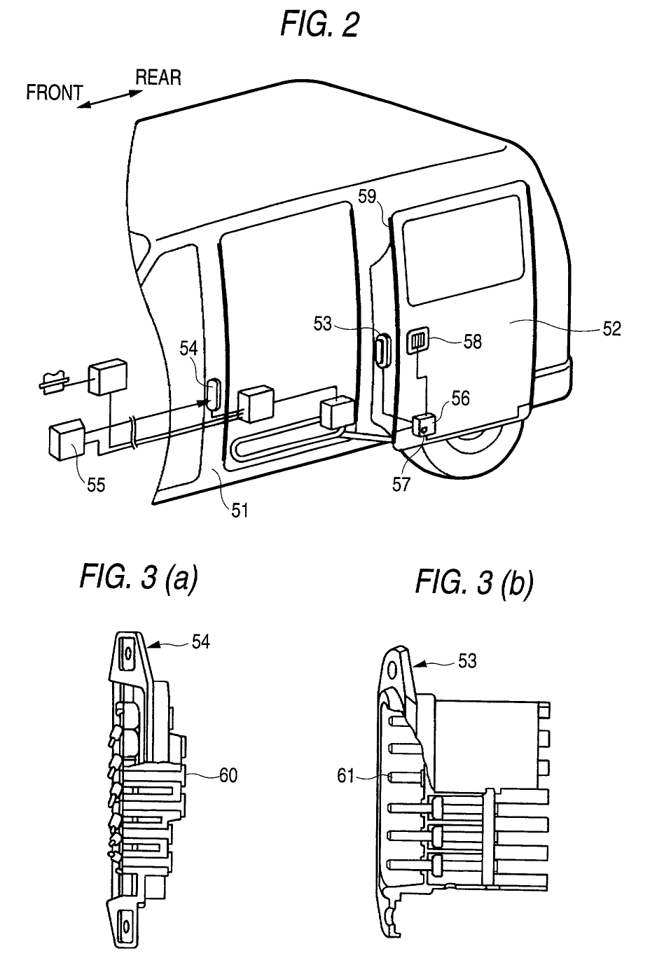

Referring now to the drawings, a description will be given of an embodiment of the invention. FIG. 1 is a block diagram illustrating an embodiment of the feeder system in accordance with the invention.

In FIG. 1, at door joining portions for joining a vehicle body 1 of a vehicle and a plurality of door units 2 (corresponding to fed members recited in the claims) which are openably provided in the vehicle body 1, feeder systems 3 for the door unit of the vehicle are provided for supplying electric power from the vehicle body 1 to the respective door units 2 through the action of mutual induction. The feeder systems 3 are provided in a number corresponding to the number of the door units 2, and each of the feeder systems 3 is comprised of a primary noncontact connector 4 provided on the vehicle body 1 side and a secondary noncontact connector 5 provided on the corresponding door unit 2. Each of the primary noncontact connectors 4 is connected to a high-voltage power supply line 6 of, for example, 36 V provided in the vehicle body 1, while each of the secondary noncontact connectors 5 is connected to a low-voltage power supply line 7 of, for example, 12 V provided in the corresponding door unit 2. Each feeder system 3 in this embodiment which is thus connected to the high-voltage power supply line 6 and the low-voltage power supply line 7 is arranged to be able to lower the voltage of the electric power supplied from the vehicle body 1 to each door unit 2 from 36 V to 12 V.

It should be noted that as the door units 2, it is possible to cite doors 2a on the driver's seat and passenger seat sides, a sliding door 2b, and a rear hatch 2c, as shown in the drawing. As the fed members recited in the claims other than the door units 2, it is possible to cite various module units including an instrument panel module. On the other hand, as the voltage at the high-voltage power supply line 6, it is possible to cite 24 V, 48 V, and the like in addition to 36 V.

A description will be given of each of the above-described arrangements. The vehicle body 1 is provided with a generator 8, a battery 9, control equipment 10, and the like in addition to the primary noncontact connectors 4 and the high-voltage power supply lines 6. The generator 8 and the battery 9 are installed in an engine compartment 11, and electric power generated by the generator 8 is charged in the battery 9. The high-voltage power supply line 6 is connected to the battery 9, and the control equipment 10 is adapted to receive the supply of electric power from the battery 9. The control equipment 10 is provided with such as a motor 12.

Each primary noncontact connector 4 is configured by having a primary core 13 and a primary coil 14 wound around the primary core 13, and the driving of its oscillation is controlled by an unillustrated primary-coil oscillation drive controller provided between the primary noncontact connector 4 and the high-voltage power supply line 6 (the primary noncontact connector 4 is indirectly connected to the high-voltage power supply line 6). To give a brief description of the unillustrated primary-coil oscillation drive controller, the unillustrated primary-coil oscillation drive controller has the function as an inverter, and is arranged to be able to control the energization of the primary coil 14.

The door 2a is provided with a battery 15, control equipment 16, and the like in addition to the aforementioned secondary noncontact connector 5 and low-voltage power supply line 7. The battery 15 is adapted to be charged with the induced electromotive force occurring in the secondary noncontact connector 5 through a rectifier circuit and a charging circuit which are not shown. The low-voltage power supply line 7 is connected to the battery 15. The control equipment 16 is connected to the low-voltage power supply line 7, and is arranged to receive the supply of electric power therefrom. The control equipment 16 is provided with such as a motor 17.

The sliding door 2b is provided with a battery 18, a control equipment 19, and the like in addition to the aforementioned secondary noncontact connector 5 and low-voltage power supply line 7. The battery 18 is adapted to be charged with the induced electromotive force occurring in the secondary noncontact connector 5 through a rectifier circuit and a charging circuit which are not shown. The low-voltage power supply line 7 is connected to the battery 18. The control equipment 19 is connected to the low-voltage power supply line 7, and is arranged to receive the supply of electric power therefrom. The control equipment 19 is provided with such as a motor 20.

The rear hatch 2c is provided with a battery 21, a control equipment 22, and the like in addition to the aforementioned secondary noncontact connector 5 and low-voltage power supply line 7. The battery 21 is adapted to be charged with the induced electromotive force occurring in the secondary noncontact connector 5 through a rectifier circuit and a charging circuit which are not shown. The low-voltage power supply line 7 is connected to the battery 21. The control equipment 22 is connected to the low-voltage power supply line 7, and is arranged to receive the supply of electric power therefrom. The control equipment 22 is provided with such as a motor 23.

Each secondary noncontact connector 5 is configured by having a secondary core 24 and a secondary coil 25 wound around the primary core 24. The aforementioned unillustrated rectifier circuit is connected to its downstream (the secondary noncontact connector 5 is indirectly connected to the low-voltage power supply line 7). The winding ratio between the secondary coil 25 and the primary coil 14 has been adjusted. Namely, in this embodiment, the winding ratio is so adjusted that the voltage of the electric power supplied from the vehicle body 1 to each door unit 2 is lowered from 36 V to 12 V. Consequently, an induced electromotive force whose voltage is lower than that of the electromotive force of the primary coil 14 is generated in the secondary coil 25 through the action of mutual induction with the primary coil 14.

In the above-described configuration, the feeder system 3 in accordance with this embodiment operates as follows. First, if an unillustrated key is inserted in an ignition switch and the ignition switch is turned on, electric power is supplied to the unillustrated primary-coil oscillation drive controller connected to the high-voltage power supply line 6. Next, when the power is supplied to the unillustrated primary-coil oscillation drive controller, an ac electromotive force is generated in the primary coil 14 of each primary noncontact connector 4 by the driving of the oscillation of the unillustrated primary-coil oscillation drive controller.

When the door 2a is closed with respect to the vehicle body 1, an induced electromotive force whose voltage is lower than that of the electromotive force of the primary coil 14 is generated in the secondary coil 25 through the action of mutual induction with the primary coil 14. The induced electromotive force thus generated is charged in the battery 15 through the unillustrated rectifier circuit and charging circuit. Incidentally, when the door 2a is open with respect to the vehicle body 1, electric power is supplied from the battery 15 to the low-voltage power supply line 7.

When the sliding door 2b is closed with respect to the vehicle body 1, an induced electromotive force whose voltage is lower than that of the electromotive force of the primary coil 14 is generated in the secondary coil 25 through the action of mutual induction with the primary coil 14. The induced electromotive force thus generated is charged in the battery 18 through the unillustrated rectifier circuit and charging circuit. Incidentally, when the sliding door 2b is open with respect to the vehicle body 1, electric power is supplied from the battery 18 to the low-voltage power supply line 7.

When the rear hatch 2c is closed with respect to the vehicle body 1, an induced electromotive force whose voltage is lower than that of the electromotive force of the primary coil 14 is generated in the secondary coil 25 through the action of mutual induction with the primary coil 14. The induced electromotive force thus generated is charged in the battery 21 through the unillustrated rectifier circuit and charging circuit. Incidentally, when the rear hatch 2c is open with respect to the vehicle body 1, electric power is supplied from the battery 21 to the low-voltage power supply line 7.

As described above, the feeder system in accordance with this embodiment is so arranged that the feeding of electric power from the vehicle body 1 to the door unit 2 is effected by the action of mutual induction between the primary coil 14 and the secondary coil 25. Accordingly, a door-side feeding contact 53 and a body-side feeding contact 54 of the conventional example (see FIG. 3) are not required, so that it is possible to overcome the problem of short-circuiting due to splashing with water and the nipping of an electrically conductive material, which has been a conventional problem. It is possible to reduce the risk against a human body such as an electric shock. It is possible to eliminate the troublesome operation of passing a wire harness between the vehicle body and the door unit, which has hitherto been performed, thereby making it possible to reduce the number of steps of operation.

The feeder system 3 in accordance with this embodiment is arranged such that when electric power is supplied from the vehicle body 1 to the door unit 2, the induced electromotive force whose voltage has been lowered is generated in the secondary coil 25. Accordingly, it is unnecessary to newly install DC-DC converters for the respective door units 2, thereby making it possible to contribute to a reduction in cost. Aside from this, it is unnecessary to provide a new power supply line on the vehicle body 1 side and draw it into the respective door units 2, thereby making it possible to contribute to the reduction of the power transmission loss. It should be noted that it goes without saying that similar advantages can be obtained in the case of not only the door units but also module units.

As can be appreciated from the above, the feeder system in accordance with this embodiment is inexpensive, and is able to improve the safety and operating efficiency and contribute to the reduction of the power transmission loss.

In addition, it goes without saying that the invention may be implemented by making various modifications within the range that does not change the gist of the invention. Namely, the primary noncontact connector 4 may be arranged to be detachable, i.e., replaceable, in correspondence with the voltage at the high-voltage power supply line 6 of the vehicle body 1. Correspondingly, the secondary noncontact connector 5 may be arranged to be detachable, i.e., replaceable, as required. It should be noted that by making the primary noncontact connector 4 and the secondary noncontact connector 5 replaceable, there is an advantage in that it is readily possible to cope with cases in which the voltage on the vehicle body 1 side is not made high due to variations based on the grade of the automobile.

As described above, in accordance with the invention, if it is assumed that the fed member is, for example, a door unit, since the feeder system is so arranged that the feeding of electric power from the vehicle body to the door unit is effected by the action of mutual induction between the primary coil and the secondary coil, it is possible to eliminate an exposed electrical contact portion for contact. Hence, it is possible to overcome the problem of short-circuiting due to splashing with water and the nipping of an electrically conductive material, which has been a conventional problem. In addition, it is possible to reduce the risk against a human body such as an electric shock. It is possible to eliminate the troublesome operation of passing a wire harness between the vehicle body and the door unit, which has hitherto been performed, thereby making it possible to reduce the number of steps of operation. Since the feeder system is arranged such that when electric power is supplied from the vehicle body to the door unit, the voltage-lowered induced electromotive force capable of being supplied to the low-voltage power supply line of the door unit is generated in the secondary coil. Accordingly, it is unnecessary to newly install DC-DC converters for the respective door units, thereby making it possible to contribute to a reduction in cost. Aside from this, it is unnecessary to provide a new power supply line on the vehicle body side and draw it into the respective door units, thereby making it possible to contribute to the reduction of the power transmission loss. Therefore, advantages are offered in that it is possible to provide a feeder system which is inexpensive, improves the safety and operating efficiency, and contributes to the reduction of the power transmission loss. It should be noted that similar advantages are obtained in the case of not only the door unit but also a module unit mounted in the automobile.

In accordance with the invention, the primary noncontact connector is arranged to be detachable with respect to the vehicle body, and the secondary noncontact connector is also arranged to be detachable with respect to the fed member. Accordingly, an advantage is offered in that it is possible to provide a versatile feeder system which is not affected by the voltage of the power supply line on the vehicle body side.

What is claimed is:

1. A feeder system for supplying electric power from a vehicle body of a vehicle to a fed member, the feeder system comprising:
a high-voltage power supply line, for supplying the electric power of first voltage, provided to the vehicle body;
a primary noncontact connector including primary coil and connected to the high-voltage power supply line;
a low-voltage power supply line, for supplying the electric power of second voltage lower than the first voltage, provided to the fed member; and
a secondary noncontact connector connected to the lower-voltage power supply line and including a secondary coil generating an induced electromotive force as the primary coil is brought into close proximity to the secondary coil, wherein the secondary coil converts the electric power of the first voltage supplied from the primary coil to the electric power of the second voltage in cooperation with the primary coil.

2. The feeder system according to claim 1, wherein the primary noncontact connector is detachable from the vehicle body, and the secondary noncontact connector is detachable from the fed member.

3. The feeder system according to claim 1, wherein
the primary noncontact connector includes a primary core around which the primary coil is wound,
the secondary noncontact connector includes a secondary core around which the secondary coil is wound, and
a winding ratio between the secondary coil and the primary coil is so set that the first voltage is converted to the second voltage.

4. The feeder system according to claim 1, wherein the first voltage is 36 V and the second voltage is 12 V.
